(19) United States
(12) Patent Application Publication
(10) Pub. No.: US 2014/0268828 A1
(43) Pub. Date: Sep. 18, 2014

(54) RETRO-FITTABLE POWER ASSEMBLY FOR CONVERSION OF RECESSED LIGHTING FIXTURE TO LED

(71) Applicant: Hubbell Incorporated, Shelton, CT (US)

(72) Inventors: Raymond A. Brown, Greer, SC (US); Christopher L. Bailey, Greenville, SC (US); Alan D. Seward, Simpsonville, SC (US)

(21) Appl. No.: 14/208,860

(22) Filed: Mar. 13, 2014

Related U.S. Application Data
(60) Provisional application No. 61/787,335, filed on Mar. 15, 2013.

(51) Int. Cl. F21V 17/00; F21K 99/00; F21V 29/00

(52) U.S. Cl. CPC F21V 17/002; F21V 29/22; F21K 9/90; F21K 9/10
USPC 362/373; 29/825

(57) ABSTRACT

A retro-fitting power door, kits, and methods for using the same to convert existing light fixtures to accommodate new lighting technologies. The retro-fitting door is sized and configured to be used in place of an existing power door, such as those found on recessed HID lighting fixtures. The retro-fitting door includes the necessary electrical components to replace those removed with the removal of the existing power door. In retro-fitting a recessed HID lighting fixture, the retro-fit door includes a power door assembly comprising a top panel and a side panel configured to substantially match the size and shape of a removable HID power door; an LED board secured to an inside face of said top panel; an LED heat sink positioned on an outside face of said top panel and adapted to dissipate heat generated with said LED board; an LED driver housing secured to an outside face of said side panel; and an electrical cable secured to an inside face of said side panel and connecting said LED board and said LED driver housing.

### CROSS-REFERENCE TO RELATED APPLICATIONS

This application claims priority under 35 U.S.C. §119(e) to U.S. Provisional Application 61/787,335, filed Mar. 15, 2013, the contents of which are hereby incorporated by reference in their entirety.

### FIELD OF THE INVENTION

The present invention relates generally to light fixtures. More particularly, the present invention relates to recessed lighting fixtures with a retro-fittable power assembly for conversion to an LED source, and methods and kits for deploying the same.

### BACKGROUND OF THE INVENTION

Lighting fixtures are known in the art. Since the invention of the incandescent light bulb, lighting fixtures have been deployed in countless environments in countless configurations. The development of the fluorescent lamp and its concomitant energy savings not only added to the universe of configurations deployed but also fueled a cost-saving demand to use fluorescent lamps wherever practicable. As will be appreciated, the different electrical requirements at play prevented the simple replacement of incandescent lamps with fluorescent lamps. The entire fixture had to be replaced.

In more recent times, the development and improvement in energy-saving

CFL technology allowed users to refrain from absorbing the cost of completely replacing a fixture by accommodating the simple exchanging out the incandescent lamps for replacement with CFLs that screwed directly into the sockets for the incandescent lamps. Thus, a CFL could be deployed inexpensively and its energy and cost savings reaped. Similar energy efficiency and cost effectiveness was realized in various commercial environments with the introduction of HID (“High Intensity Discharge”) lamps.

Today, there has been a paradigm shift to the use of LED (“Light emitting diode”) light sources. Unlike its predecessors, LEDs do not lend themselves to the simple exchange of lamps. As will be appreciated, LEDs do not use the ballast of light fixtures found in other lighting methods, but rather an LED driver, LED board, and heat sink to allow the lamps to operate correctly. As such, anyone considering the energy or cost savings of switching to LEDs where other light sources are presently deployed would have to factor in the cost of replacing the entire fixture. Such an undertaking may be deemed cost prohibitive in all but a handful of situations such as where required by code or regulation, in times of remodeling, new construction, and/or obsolescence or maintenance replacements.

Accordingly, there exists a need in the art for a lighting fixture adapted to be capable of retro-fitting for new technology. There also exists a long-felt, yet unresolved, need in the art for a retro-fittable light fixture adapted to accept LED technology. Likewise, there exists a long-felt, yet unresolved, need in the art for a kit and methods for retro-fitting existing light fixtures with LED technology.

### SUMMARY OF THE INVENTION

Various embodiments of the present invention overcome various of the aforementioned and other disadvantages associated with prior art light fixtures, and in particular, retro-fitting light fixtures to accommodate changes in lighting technology. The present invention is based, in part, on the discovery that existing light fixtures may be configured in a manner to facilitate retro-fitting a new power assembly. The present invention is also based, in part, on the discovery that existing light fixtures may be configured to receive a retro-fittable power assembly for conversion to an LED source. The present invention is also based, in part, on the discovery that existing recessed lighting fixtures and the like that have pivotable or removable panels to facilitate maintenance of the major electrical components may be retro-fitted with a new power assembly through use of replacement panels. Finally, the present invention is also based, in part, on the discovery that the novel methods and configurations disclosed herein lend themselves to incorporation into a kit that is adaptable and able to allow for existing light fixtures, such as recessed HID fixtures, to be converted to a new power source, such as LED, in the field.

According to one aspect of various embodiments of the present invention there is provided a light fixture housing having a removable side panel and top panel integrated with the power and/or illumination source that may be removed and replaced with a new side panel and top panel including the elements of a new power and/or illumination source.

According to an advantageous embodiment of this aspect of the invention there is provided a recessed HID light fixture having a power panel assembly that is movable for maintenance purposes that is replaced in situ with a power panel assembly adapted for LED illumination. One advantageous feature according to this embodiment of the invention is the ability to use the existing hinges/mounting means for removing and replacing the power panels. According to another advantageous feature according to this embodiment of the invention is the ability to use purely mechanical means for removing and replacing the panels in the field. According to a related feature of this embodiment of the invention, quarter turn fasteners are used to selectively hold the top panel of a power panel assembly in place.

According to an advantageous embodiment of the invention, there is provided a recessed HID light fixture having a pivotable top panel and side panel assembly including the ballast cover, wiring conduit, and socket assembly integral therewith that may be removed entirely and replaced in the field with a power panel assembly comprising a side panel and top panel having an LED driver cover, electrical cable, LED board and heat sink integral therewith. According to this embodiment of the invention, an advantageous feature of the invention is the provision of the driver cover on the outside of the panel and the cable on the inside of the panel terminating with the LED board on the underside of the top panel while the heat sink is maintained on or above the top side of the top panel.

The invention as described and claimed herein should become evident to a person of ordinary skill in the art given the following enabling description and drawings. The aspects and features of the invention believed to be novel and other elements characteristic of the invention are set forth with particularity in the appended claims. The drawings are for illustration purposes only and are not drawn to scale unless otherwise indicated. The drawings are not intended to limit the scope of the invention. The following enabling disclosure is directed to one of ordinary skill in the art and presupposes that those aspects of the invention within the ability of the ordinarily skilled artisan are understood and appreciated.

### BRIEF DESCRIPTION OF THE DRAWINGS

The above benefits and other advantages of the various embodiments of the present invention will be more apparent from the following detailed description of exemplary embodiments of the present invention and from the accompanying drawing figures, in which:

FIG. 1 depicts a cross-sectional view of an embodiment of a prior art recessed 2′×2′ HID parabolic light fixture.

FIG. 2 depicts an embodiment of an LED replacement power assembly and panel composite for retro-fitting the light fixture of FIG. 1.

FIG. 3 depicts a bottom perspective view of an embodiment of a retro-fitted recessed 2′×2′ HID light fixture housing in the open position.

FIG. 4 depicts a bottom perspective view of the retro-fitted recessed 2′×2′ HID light fixture housing of FIG. 3 in the closed position.

FIG. 5 depicts a top perspective view the light fixture housing of FIG. 3 with the side panel in place and the top panel being positioned for closure.

FIG. 6 a depicts a top perspective view of the light fixture housing of FIG. 3 in the closed position.

FIG. 7 depicts a bottom perspective view of the light fixture housing of FIG. 3 in the closed position.

### DETAILED DESCRIPTION OF THE EXEMPLARY EMBODIMENTS

While the present invention will be described in connection with the retro-fitting of an existing recessed HID light fixture, it will be readily apparent to one of ordinary skill in the art armed with the present specification that the present invention can be applied to a multiplicity of fields and uses. In particular, the present invention may find use in other areas where retrofitting in the field is desirable. Likewise, the present invention may be advantageous in the manufacturing of new light fixtures and other housings that may be subject to anticipated retro-fitting. Finally, one of ordinary skill in the art armed with the present specification will also understand that the present system may be easily modified to include different configurations, mechanisms, methods, and kits, which achieve the purposes of the present invention.

FIG. 1 depicts a prior art recessed HID light fixture commonly deployed in today's marketplace. As with various other recessed fixtures known in the art, the housing of the fixture is adapted to allow for servicing of the electrical components in the field. With recessed fixtures, and other fixtures as well, the servicing is often achieved by the provision of portions of the housing that are removable, pivottable, or foldable to expose the major parts of the power and illumination system to the tools or hands of the servicer.

With specific reference to FIG. 1, the recessed HID light fixture 1 is found generally in the form of a frustum of a square. The frustum shape is formed by the connection of four sheet metal trapezoidal side panels 20 and a top panel 30. Three of the side panels 20 are fastened together at abutting lateral flanges, while the fourth 20A is removably connected or hinged to its neighbor panels at the base of the housing in a manner that allows the panel to swing freely into and out of a “frame” formed from the lateral flanges of the neighbor panels.

The hinged side panel 20A is also hinged or otherwise connected to the top panel 30 or at least a portion of the top panel 35 of the fixture 1. The side panel-to top panel/portion composite 40 is referred to as the “power door” 40 for the obvious reason that its maneuverability serves the purpose of exposing the power components of the fixture for servicing in the field. The power door 40 is held in place by ¹/4 turn fasteners 45 disposed on the top panel 30.

The underside of the top panel 35 includes the socket assembly 50 for receiving the HID lamp 60. The socket assembly 50 wiring extends into a housing 55 affixed to the back of the top panel 30. Extending from the socket wiring housing 55 and alongside the power door 40 is the 70 wiring conduit carrying the electrical wiring from a ballast 80 housed in a cover mounted at the base of the power door 40 side panel 20A.

Also disposed in an area of the base of the side panels is a glass overlay 90 and louver assembly 95 that provide the desired light dispersion and aesthetic appearance to the bottom of the fixture. As will be appreciated, this configuration allows the fixture to be wired to the building electricity and then recessed into the plenum of the building leaving nothing but the glass overlay 90 and louver exposed 95 to the line of sight of the occupants of the building. Furthermore, as will also be appreciated, when the electrical components of the feature need servicing, whether it be a replacement lamp, wiring, or ballast issue, the user simply removes the louver 95 and glass overlay to access the ¼ turn fasteners 45 to allow the power door 40 to be swung through the interior of the fixture into the open and down position thereby exposing the socket assembly 50, socket wiring housing 55, HID lamp 60, wiring conduit 70 and the ballast housing 80 in the ambient environment for servicing.

As discussed earlier, when upgrading to a new technology that required a different power source or other electrical features, prior artisans removed the entire fixture and replaced it with a new one embodying the new technology. This would include replacing recessed HID fixtures. However, the present inventors have gone against the great weight of authority and credulity in the art in conceiving of a kit to retro-fit existing light fixtures, and in particular, those already having mechanical means for accessing and servicing the major electrical components.

At its simplest, a presently preferred embodiment for retro-fitting recessed HID fixtures for conversion to LED includes a retro-fittable power assembly 100 and/or a kit for implementing the conversion, generally depicted in FIG. 2.

Existing commercially available lighting fixtures that may be retro-fitted according to various embodiments of the invention include the HH22 Lensed Vertical Lamp Troffer, HV22 Lensed Vertical Lamp Troffer, and HH22 Lensed Horizontal Lamp Troffer of Columbia Lighting (a division of Hubbell Lighting, Inc.), the details of which are publicly available in the cut-sheets for the fixtures, which are hereby incorporated by reference in their entirety.

As shown in the various Figures, the assembly 100 includes a side panel 200 member and top panel member 300 joined to form a power door 400 assembly that is sized and shaped to be used in place of, and to the exclusion of, the existing prior art power door 40 of the prior art fixture 10 of FIG. 1. In an alternative embodiment, the existing power door could be removed, modified to include the necessary electrical parts for the retro-fit and then replaced. Such an embodiment lends itself to a kit for field use where feasible. However, in the embodiment shown in the Figures, the substantial change in components is more suitable to the swapping out of doors then it is for the modification of components.

As will be appreciated, when the existing power door 40 is removed, the light source 60, socket assembly 50, wiring 55, conduit 70, and ballast 80 are all removed from the fixture 10 completely. The new power assembly 100 includes the electrical components that are necessary to replace those that were removed for the retro-fitted technology being employed. According to the present embodiment shown in FIG. 2, the conversion to LED utilizes a heat sink/heat pipe unit 500 disposed on or above the top side of the top panel 300 and an LED board 600 disposed on the underside, the necessary wiring/cable conduit 700, and an LED driver housing 800. As will be appreciated, other conversions and future conversions will dictate what components are and are not included.

In operation, as best shown in FIGS. 3-7, the retro-fitting of the fixture 10 starts removal of the louver and glass overlay to allow access to the cavity of the fixture housing. Once accessible, the ¼ turn fasteners are actuated to allow the power door to gravitationally swing freely open. Then, the fixture assembly is disconnected from the building electrical wiring. The existing power door is then removed from the housing hinges. As best shown in FIG. 3, the LED power door 400 is connected to the housing hinges. Notably, as shown in FIG. 3, the LED driver housing 800 and heat sink/heat pipe assembly 500 are secured on the outside face of the side panel 200 and top panel 300 respectively and the fixture reconnected to the building electrical wiring. Thus, when the power door assembly 400 is swung into the closed position, as depicted in FIG. 4, the LED driver housing 800 and heat sink/heat pipe assembly 500 are positioned on the outside of the fixture housing.

As best shown in FIG. 5, a particular advantageous aspect of this embodiment is the ability to have the heat sink 500 come through the existing opening in the housing before the top panel 300 is closed and secured in place by the ¹/4 turn fasteners 450. Once secured in place, the heat sink 500 and LED driver housing 800 are on the outside of the housing, as best shown in FIG. 6, and the LED board 600 and cable 700 are secured in the interior of the housing, as best shown in FIG. 7. After assembly of the housing and securing the housing panels, the glass overlay and louver may be repositioned and the fixture reconnected to the building electrical wiring. The recessed HID fixture has now been successfully retro-fitted to an LED fixture.

As will now be readily appreciated by one of ordinary skill in the art armed with the present specification, the inventive methods of the present invention lend themselves to retro-fitting existing lighting fixtures that have removable or pivotable portions that provide access to the major electrical components of the fixture. Likewise, it will be appreciated that the inventive methods lend themselves to the forming of metal housing substrates to include the power components on removable portions of the housings to facilitate the retro-fitting of the fixture in the future. Similarly, it will be appreciated that the inventive methods of the present invention lend themselves to the provision of retro-fitting kits to ease the retro-fitting of fixtures in the field.

The foregoing embodiments and advantages are merely exemplary and are not to be construed as limiting the scope of the present invention. The description of an exemplary embodiment of the present invention is intended to be illustrative, and not to limit the scope of the present invention. Various modifications, alternatives and variations will be apparent to those of ordinary skill in the art, and are intended to fall within the scope of the invention.

I claim:

1. A retro-fitting LED assembly for an HID light fixture housing having a power door comprising:
a power door assembly comprising a top panel and a side panel configured to substantially match the size and shape of a removable HID power door;
an LED board secured to an inside face of said top panel;
an LED heat sink positioned on an outside face of said top panel and adapted to dissipate heat generated with said LED board;
an LED driver housing secured to an outside face of said side panel; and
an electrical cable secured to an inside face of said side panel and connecting said LED board and said LED driver housing.

2. A kit for retro-fitting a recessed HID light fixture comprising:
a power door assembly comprising a top panel and a side panel configured to substantially match the size and shape of a removable HID power door;
an LED board secured to an inside face of said top panel;
an LED heat sink positioned on an outside face of said top panel and adapted to dissipate heat generated with said LED board;
an LED driver housing secured to an outside face of said side panel; and
an electrical cable secured to an inside face of said side panel and connecting said LED board and said LED driver housing.

3. A method of retro-fitting a light fixture comprising:
removing a power panel from said light fixture;
replacing said power panel with a retro-fit power panel comprising a power door having integral therewith electrical components sufficient to power said light fixture.
